(19) United States
(12) Patent Application Publication
(10) Pub. No.: US 2017/0011841 A1
(43) Pub. Date: Jan. 12, 2017

(54) Transformer Structure

(71) Applicant: CYNTEC CO., LTD., Hsinchu (TW)

(72) Inventors: Shih-Feng Chien, Hsinchu (TW); Lu-Kuei Lin, Hsinchu (TW); I-Feng Lin, Hsinchu (TW)

(73) Assignee: CYNTECO CO., LTD., Hsinchu (TW)

(21) Appl. No.: 14/980,358

(22) Filed: Dec. 28, 2015

(30) Foreign Application Priority Data
Jul. 7, 2015 (TW) 104122080

(51) Int. Cl. H01F 27/28; H01F 27/24

(52) U.S. Cl. CPC H01F 27/2823; H01F 27/24

(57) ABSTRACT

A transformer structure with high magnetic permeability utilization is provided. The transformer structure includes a first magnetically permeable unit, at least one winding and a second magnetically permeable unit. The winding is wound around a winding portion of the first magnetically permeable unit to generate magnetic flux in the winding portion of the first magnetically permeable unit. The first magnetically permeable unit includes a first coupling structure and the second magnetically permeable unit includes a second coupling structure. The first coupling structure and the second coupling structure extend to an edge area of the transformer structure. The magnetic flux from the winding portion of the first magnetically permeable unit flows to the first coupling structure and the second coupling structure in sequence when the first coupling structure is coupled to the second coupling structure.

### FIELD OF THE INVENTION

The present disclosure relates to a transformer structure, and particularly to a transformer structure applied in a communication field.

### BACKGROUND OF THE INVENTION

Pulse transformers, e.g. wideband transmission transformers, are usually used in electronic devices for communication to transmit digital signals in Internet or local area network (LAN). Please refer to FIG. 1, a schematic diagram illustrating a conventional pulse transformer. The pulse transformer 1 includes a drum core 11, a plate core 12 and windings 13. The drum core 11 includes a winding portion 111 and flanges 112 connected to two ends of the winding portion 111. The windings 13 are wound around the winding portion 111. The plate core 12 is disposed on the drum core 111, and portions of the plate core 12 are connected to the flanges 112 to form contact surfaces 14. The contact surfaces 14 are flat surfaces parallel to the bottom surface of the plate core 12.

Without the plate core 12, the drum core 11 with the windings 13 will form an open magnetic flux path, which causes reduction of the inductance. Hence, to construct a close magnetic flux path, the plate core 12 is provided and connected to the flanges 112 by applying a binder (not shown) to the contact surfaces 14. Thus, the drum core 11 with the windings 13 and the plate core 12 form a close magnetic flux path to maintain the inductance. However, although the inductance of the close magnetic flux path is higher than that of the open magnetic flux path, there exist air gaps at the contact surfaces 14 which cause flux leakage.

Please refer to FIG. 2 which illustrates the magnetic flux in the pulse transformer 1. The contact surfaces 14 are flat surfaces parallel to the lengthwise direction of the plate core 12, and the direction of the magnetic flux changes abruptly near the contact surfaces 14. At edges (corners) A (far from the contact surfaces 14) of the plate core 12, a portion of the magnetic flux diverges and flux leakage occurs. The flux density at the edges A decreases and magnetic permeability utilization of the magnetic material is unsatisfactory. Hence, the inductance of the pulse transformer 1 is restricted.

Therefore, a transformer structure with high inductance is desired to solve the edge effect and improve the magnetic performance of the transformer structure.

### SUMMARY OF THE INVENTION

The present disclosure provides a transformer structure. The transformer structure includes a first magnetically permeable unit and a second magnetically permeable unit. The first magnetically permeable unit has a winding portion and a protruding portion connected to an end of the winding portion. The protruding portion includes a protruding body and a first coupling structure connected to the protruding body. At least one winding is wound around the winding portion of the first magnetically permeable unit to generate magnetic flux in the winding portion of the first magnetically permeable unit. The second magnetically permeable unit includes a second coupling structure coupled to the first coupling structure. The first coupling structure and the second coupling structure extend to an edge area of the transformer structure so that the magnetic flux from the winding portion of the first magnetically permeable unit flows to the protruding body, the first coupling structure and the second coupling structure in sequence.

In an embodiment, the protruding body and the first coupling structure are made of the same material and integrally formed.

In an embodiment, the second magnetically permeable unit further includes a plate body connected to the second coupling structure. The magnetic flux from the winding portion of the first magnetically permeable unit flows to the protruding body, the first coupling structure, the second coupling structure and the plate body in sequence.

In an embodiment, the plate body and the second coupling structure are made of the same material and integrally formed.

In an embodiment, the first coupling structure or the second coupling structure has a shape of a triangular prism with a right triangle base or a shape of a tetragonal prism with a right-angled trapezoid base.

In an embodiment, the first magnetically permeable unit is a drum core and the second magnetically permeable unit is a plate core.

In an embodiment, the first magnetically permeable unit is an E-type core and the second magnetically permeable unit is an I-type core.

Another aspect of the present disclosure provides a transformer structure. The transformer structure includes a first magnetically permeable unit and a second magnetically permeable unit. The first magnetically permeable unit has a winding portion and a protruding portion connected to an end of the winding portion. The protruding portion includes a protruding body and a first coupling structure connected to the protruding body. At least one winding is wound around the winding portion of the first magnetically permeable unit to generate magnetic flux in the winding portion of the first magnetically permeable unit. The second magnetically permeable unit includes a plate body and a second coupling structure connected to the plate body. The second coupling structure is coupled to the first coupling structure. The first coupling structure and the second coupling structure extend to an edge area of the transformer structure at least one side of the transformer structure. A portion of the magnetic flux flows from the winding portion of the first magnetically permeable unit to the protruding body, the first coupling structure and the plate body in sequence. Another portion of the magnetic flux flows from the winding portion of the first magnetically permeable unit to the protruding body, the second coupling structure and the plate body in sequence.

In an embodiment, the first coupling structure and the second coupling structure have a shape of a rectangular cuboid. A height of the first coupling structure corresponds to a thickness of the second magnetically permeable unit, and a length of the second coupling structure corresponds to a width of the protruding portion of the first magnetically permeable unit.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is schematic diagram illustrating a conventional pulse transformer;

FIG. 2 illustrates magnetic flux in the pulse transformer of FIG. 1;

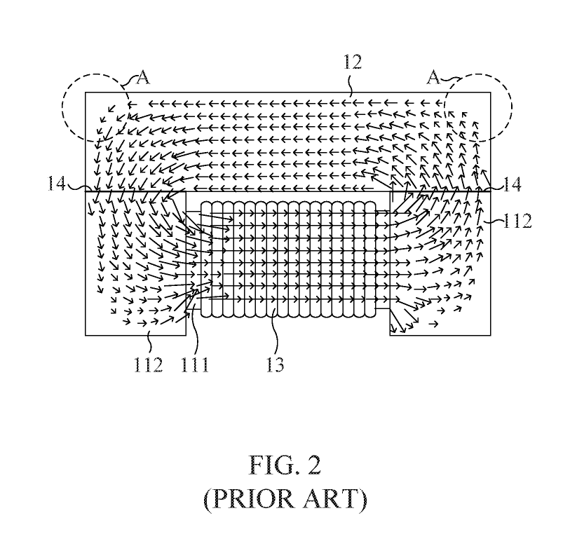

FIG. 3A is a perspective view illustrating a transformer structure according an embodiment of the present invention;

FIG. 3B is a perspective view illustrating shapes of the magnetically permeable units of the transformer structure of FIG. 3A;

FIG. 3C is a side view of the transformer structure of FIG. 3A;

FIG. 3D is a bottom view illustrating the windings of the transformer structure of FIG. 3A;

FIG. 4 illustrates magnetic flux in the transformer structure of FIG. 3A;

FIG. 5A is a side view illustrating a transformer structure according to another embodiment of the present invention;

FIG. 5B is a side view illustrating a transformer structure according to a further embodiment of the present invention;

FIG. 6A is a perspective view illustrating a transformer structure according to a further embodiment of the present invention;

FIG. 6B is a perspective view illustrating shapes of the magnetically permeable units of the transformer structure of FIG. 6A;

FIG. 6C is a side view of the transformer structure of FIG. 6A;

FIG. 7 illustrates magnetic flux in the transformer structure of FIG. 6A;

FIG. 8 is a side view illustrating a transformer structure according to a further embodiment of the present invention;

FIG. 9 is a side view illustrating a transformer structure according to a further embodiment of the present invention; and

FIG. 10 is a plot showing the relation between inductance and current of the present transformer structure and the conventional transformer structure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

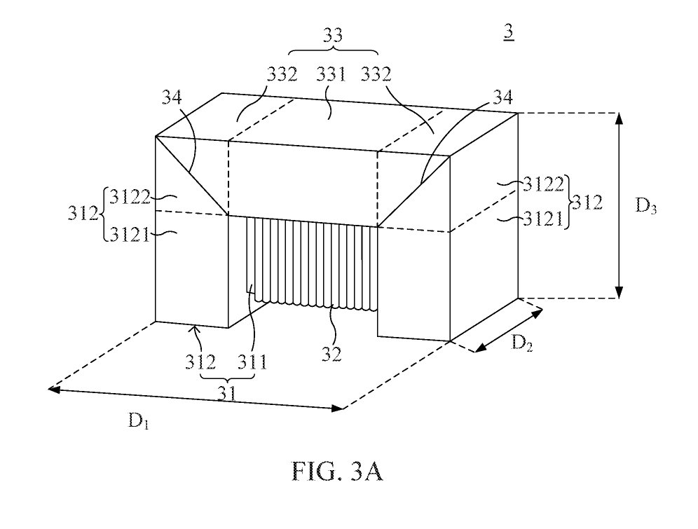

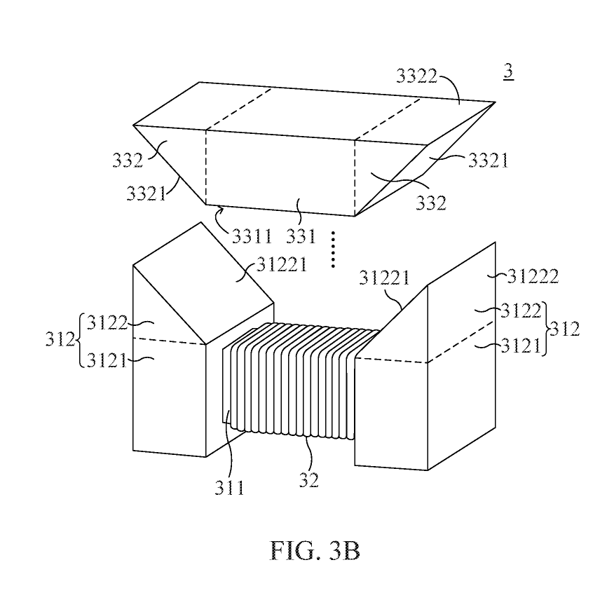

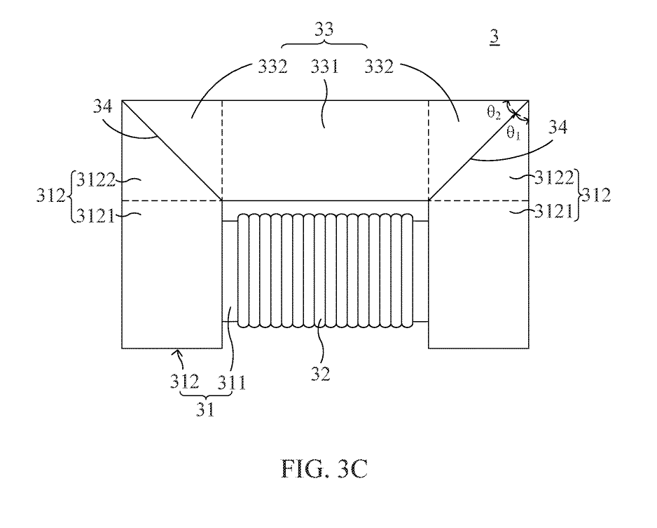

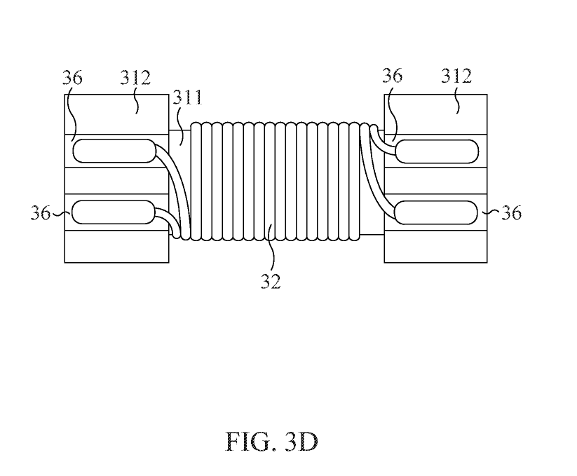

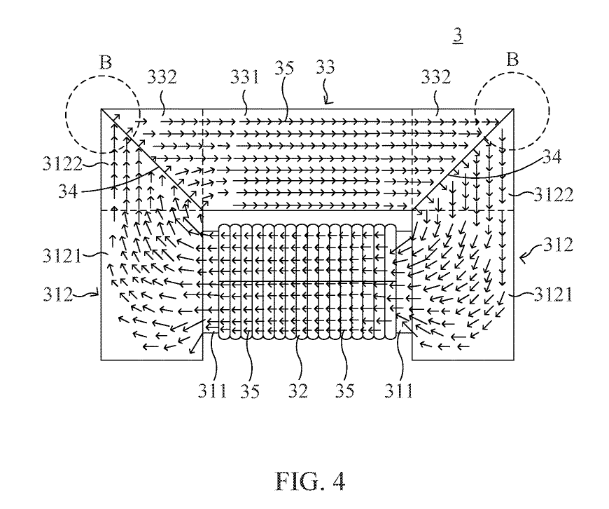

Please refer to FIGS. 3A˜3C, schematic diagrams illustrating a transformer structure according to an embodiment of the present invention. The transformer structure 3 includes a first magnetically permeable unit 31, a second magnetically permeable unit 33 and winding(s) 32. The first magnetically permeable unit 31 includes a winding portion 311 and two protruding portions 312 connected to two ends of the winding potion 311. Each of the protruding portions 312 has a protruding body 3121 and a first coupling structure 3122 connected to the protruding body 3121. The protruding body 3121 and the first coupling structure 3122 are made of the same material and integrally formed. The windings 32 are wound around the winding portion 311 to generate magnetic flux 35 as shown in FIG. 4. The second magnetically permeable unit 33 includes a plate body 331 and two second coupling structures 332 connected to two ends of the plate body 331. The plate body 331 and the second coupling structures 332 are made of the same material and integrally formed. The plate body 331 has a plate surface 3311 facing toward the winding portion 311 of the first magnetically permeable unit 31.

The material of the first magnetically permeable unit 31 and the second magnetically permeable unit 33 is a magnetically permeable material. In this embodiment, the first magnetically permeable unit 31 and the second magnetically permeable unit 33 are a drum core and a plate core, respectively, but the types of the magnetically permeable units 31 and 33 are not limited to the embodiment.

In this embodiment, two first coupling structures 3122 and two second coupling structures 332 are provided in the transformer structure 3. However, the number of the coupling structure pair can be adjusted according to the real applications. For example, the first magnetically permeable unit 31 and the second magnetically permeable unit 33 include a single first coupling structure 3122 and a single second coupling structure 332, respectively.

The first coupling structures 3122 are coupled to the corresponding second coupling structures 332 to assembly the first magnetically permeable unit 31 and the second magnetically permeable unit 33. Contact surfaces 34 are formed between the coupled structures 3122 and 332. The contact surfaces 34 are not parallel to the plate surface 3311/the lengthwise direction of the plate body 331. For example, each first coupling structure 3122 has a first slant surface 31221 and each second coupling structure 332 has a second slant surface 3321 corresponding to the first slant surface 31221. Therefore, the first coupling structure 3122 is coupled to the second coupling structure 332 by connecting the slant surfaces 31221 and 3321, and the resultant contact surface 34 is a slant surface which is not parallel to the plate surface 3311/the lengthwise direction of the plate body 331. A binder may be applied to the contact surface 34 to firmly fix the second magnetically permeable unit 33 to the first magnetically permeable unit 31.

Please refer to FIG. 3D, a bottom view illustrating the windings 32 of the transformer structure 3. The transformer structure 3 further includes electrode structures 36, e.g. lead-frames, electroplated electrodes or terminal silver electrodes, electrically connected to the windings 32. The electrode structures 36 may be disposed on bottom surfaces of the protruding portions 312 and electrically connected to corresponding terminals of the windings 32. It is to be noted that the positions of the electrode structures 36 may be changed according to real applications.

Please refer to FIG. 4 illustrating the magnetic flux 35 in the transformer structure 3. The first magnetically permeable unit 31 and the second magnetically permeable unit 33 are assembled by coupling the first coupling structure 3122 and the second coupling structure 332. The magnetic flux 35 prefers to flow along a continuous structure with a single type of material rather than cross discontinuous structures or structures with different materials. Since the protruding body 3121 and the first coupling structure 3122 are made of the same material and integrally formed, the magnetic flux 35 from the protruding body 3121 prefers to flow along the first coupling structure 3122 rather than enter the second magnetically permeable unit 33. Therefore, the magnetic flux 35 passes through the winding portion 311, the left protruding body 3121, the left first coupling structure 3122, the left contact surface 34, the left second coupling structure 332, the plate body 331, the right second coupling structure 332, the right contact surface 34, the right first coupling structure 3122, the right protruding body 3121 in sequence and flows back to the winding portion 311. The left first coupling structure 3122 and the right second coupling structure 332 guide the magnetic flux 35 to reach edge areas B to increase the magnetic permeability utilization of the magnetically permeable units 31 and 33. Hence, the inductance of the transformer structure 3 is improved. Furthermore, the magnetic flux 35 orthogonally or substantially orthogonally passes the contact surfaces 34, and this condition significantly reduces the flux leakage between the two magnetically permeable units 31 and 33.

As shown in FIG. 3B, the coupling structures 3122 and 332 have a shape of a triangular prism with a right triangle base. As shown in FIG. 3C, there is an angle θ₁ between the first slant surface 31221 and a lateral surface 31222 of the first coupling structure 3122, and 0<θ₁<90°. There is an angle θ₂ between the second slant surface 3321 and a top surface 3322 of the second coupling structure 332, and 0<θ₂<90°. The angles θ₁ and θ₂ are complementary angles so that the lateral surface 31222 of the first coupling structure 3122 and the top surface 3322 of the second coupling structure 332 may define a right-angled edge area B after the coupling of the first coupling structure 3122 and the second coupling structure 332. Compared to the prior arts, the flux density at the edge areas B increases. Therefore, the magnetic permeability utilization of the magnetically permeable units 31 and 33 and the inductance of the transformer structure 3 are improved.

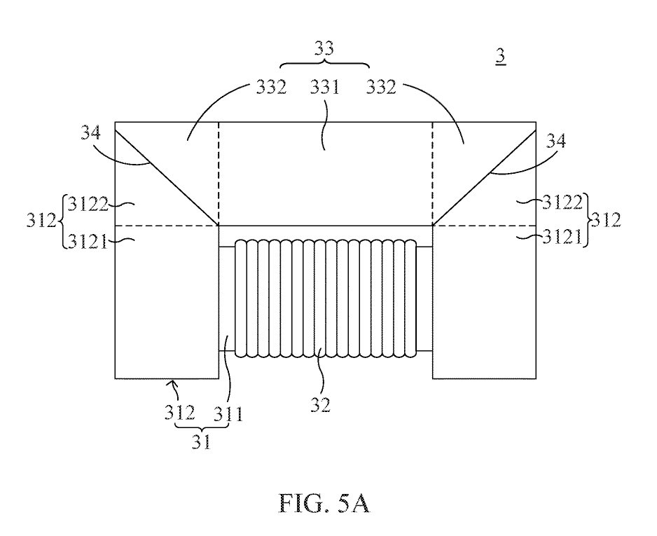

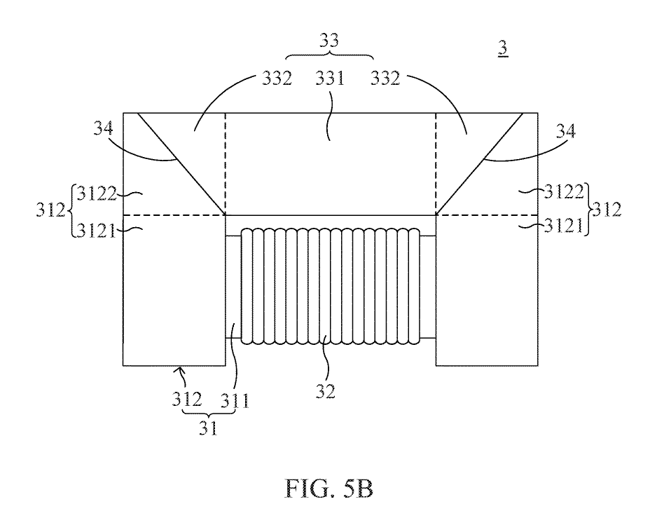

It is to be noted that the shape of the first coupling structure 3122 and the second coupling structure 332 are not limited to the triangular prism. According to the present disclosure, it is required that the first coupling structure 3122 and the second coupling structure 332 extend to the edge area (corner) B. The edge area B can be a right-angled edge area defined by the coupled first and second coupling structures 3122 and 332. Therefore, the magnetic flux 35, which flows from the first magnetically permeable unit 31 to the second magnetically permeable unit 33, flows along the first coupling structure 3122 near the edge area B and then enters the second coupling structure 332. The magnetic flux 35, which flows from the second magnetically permeable unit 33 to the first magnetically permeable unit 31, flows along the second coupling structure 332 near the edge area B and than enters the first coupling structure 3122. Thus, the first magnetically permeable unit 31 and the second magnetically permeable unit 33 are utilized completely. Please refer to FIG. 5A and FIG. 5B illustrating another embodiments of the transformer structures. In FIG. 5A, the first coupling structure 3122 has a shape of a triangular prism with a right triangle base, and the second coupling structure 332 has a shape of a tetragonal prism with a right-angled trapezoid base. In FIG. 5B, the first coupling structure 3122 has a shape of a tetragonal prism with a right-angled trapezoid base, and the second coupling structure 332 has a shape of a triangular prism with a right triangle base.

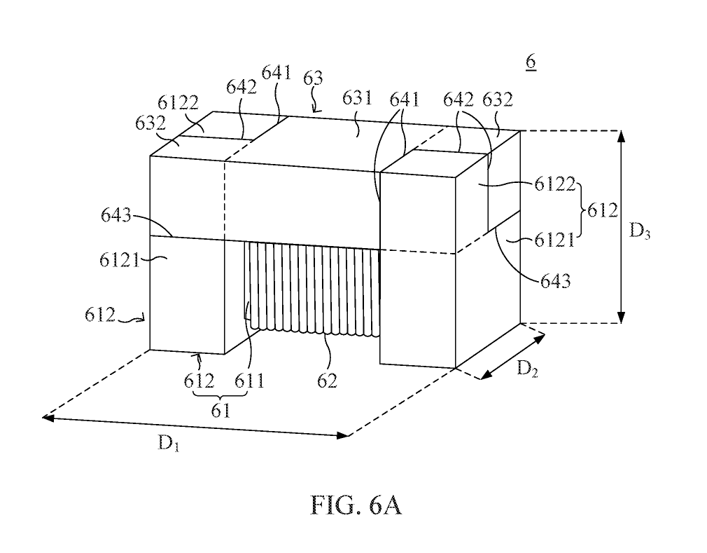

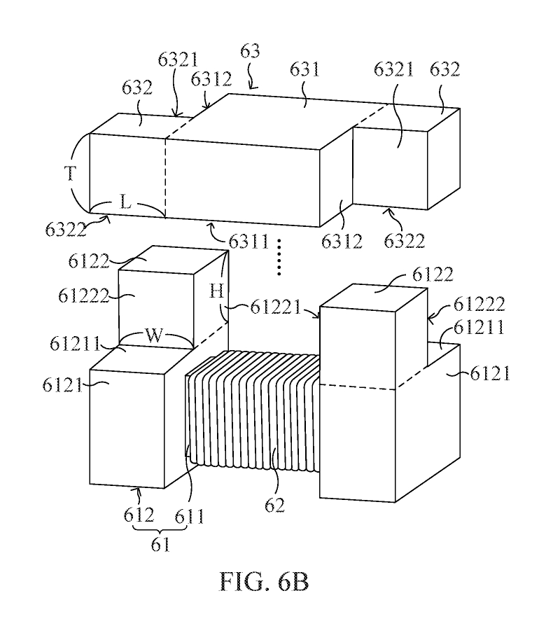

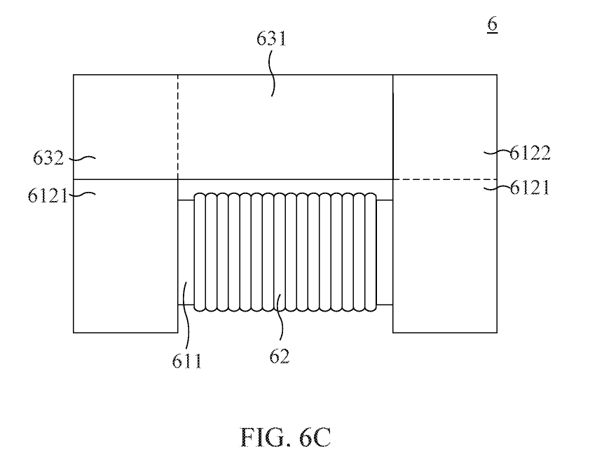

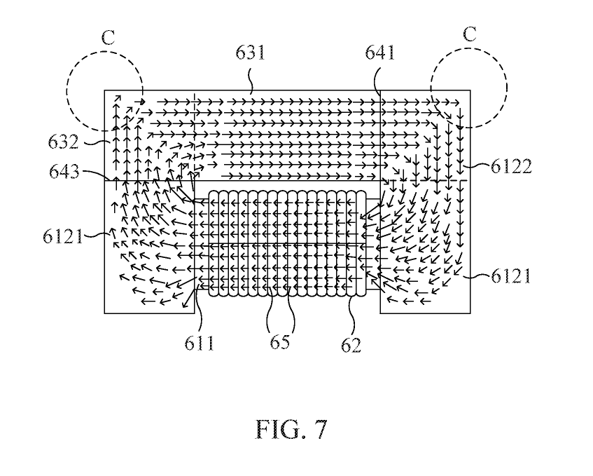

Please refer to FIGS. 6A-6C, schematic diagrams illustrating a transformer structure according to a further embodiment of the present invention. The transformer structure 6 includes a first magnetically permeable unit 61, a second magnetically permeable unit 63 and winding(s) 62. The first magnetically permeable unit 61 includes a winding portion 611 and two protruding portions 612 connected to two ends of the winding potion 611. Each of the protruding portions 612 has a protruding body 6121 and a first coupling structure 6122 connected to the protruding body 6121. The protruding body 6121 and the first coupling structure 6122 are made of the same material and integrally formed. The windings 62 are wound around the winding portion 611 to generate magnetic flux 65 as shown in FIG. 7. The second magnetically permeable unit 63 includes a plate body 631 and two second coupling structures 632 connected to two ends of the plate body 631. The plate body 631 and the second coupling structures 632 are made of the same material and integrally formed. The plate body 631 has a plate surface 6311 facing toward the winding portion 611 of the first magnetically permeable unit 61.

The material of the first magnetically permeable unit 61 and the second magnetically permeable unit 63 is a magnetically permeable material. In this embodiment, the first magnetically permeable unit 61 and the second magnetically permeable unit 63 are a drum core and a plate core, respectively, but the types of the magnetically permeable units 61 and 63 are not limited to the embodiment.

The first coupling structures 6122 are coupled to the corresponding second coupling structures 632 to assembly the first magnetically permeable unit 61 and the second magnetically permeable unit 63. Contact surfaces, i.e. first contact surfaces 641, second contact surfaces 642 and third contact surfaces 643, are formed between the first magnetically permeable unit 61 and the second magnetically permeable unit 63. The second contact surfaces 642 are formed between the coupled structures 6122 and 632. The second contact surfaces 642 are not parallel to the plate surface 6311/the lengthwise direction of the plate body 631. For example, each first coupling structure 6122 and each second coupling structure 632 have a shape of a rectangular cuboid. Each first coupling structure 6122 has a first lateral surface 61221 and a second lateral surface 61222, and each second coupling structure 632 has a lateral surface 6321 corresponding to the second lateral surface 61222 of the first coupling structure 6122. The height H of the first coupling structure 6122 corresponds to the thickness T of the second magnetically permeable unit 63. The length L of the second coupling structure 632 corresponds to the width W of the protruding portion 612 of the first magnetically permeable unit 61. Therefore, the first coupling structure 6122 is coupled to the second coupling structure 632 by connecting the second lateral surfaces 61222 and the lateral surface 6321, and the resultant second contact surface 642 is a vertical surface which is perpendicular or substantially perpendicular to the plate surface 6311/the longwise direction of the plate body 631. Furthermore, the first lateral surface 61221 of the first coupling structure 6122 is connected to a lateral surface 6312 of the plate body 631 to form the first contact surface 641, and a top surface 61211 of the protruding body 6121 is connected to a bottom surface 6322 of the second coupling structure 632 to form the third contact surface 643. The contact surfaces 641, 642 and 643 are perpendicular or substantially perpendicular to each other. The lateral surface 61221 of the left first coupling structure 6122 faces rightwards, and the lateral surface 61221 of the right first coupling structures 6122 faces leftwards. Positions of the two first coupling structures 6122 are staggered along a widthwise direction of the plate body 631, and so do positions of the two second coupling structures 632. For example, the left first coupling structure 6122 is behind the left second coupling structure 632, while the right second coupling structure 632 is behind the right first coupling structure 6122. A binder may be applied to the contact surfaces 641, 642 and 643 to firmly fix the second magnetically permeable unit 63 to the first magnetically permeable unit 61.

Please refer to FIG. 7 illustrating the magnetic flux 65 in the transformer structure 6. The first magnetically permeable unit 61 and the second magnetically permeable unit 63 are assembled by coupling the first coupling structure 6122 and the second coupling structure 632. The magnetic flux 65 prefers to flow along a continuous structure with a single type of material rather than cross discontinuous structures or structures with different materials. Since the protruding body 6121 and the first coupling structure 6122 are made of the same material and integrally formed, the magnetic flux 65 from the protruding body 6121 prefers to flow along the first coupling structure 6122 rather than enter the second magnetically permeable unit 63. Similarly, since the plate body 631 and the second coupling structures 632 are made of the same material and integrally formed, the magnetic flux 65 from the plate body 631 prefers to flow along the second coupling structure 632 rather than enter the first magnetically permeable unit 61. Therefore, for a half of the magnetic flux 65 near the viewer, the magnetic flux 65 passes through the winding portion 611, the left protruding body 6121, the left third contact surface 643, the left second coupling structure 632, the plate body 631, the right first contact surface 641, the right first coupling structure 6122, the right protruding body 6121 in sequence and flows back to the winding portion 611. The other half of the magnetic flux 65 passes through the winding portion 611, the left protruding body 6121, the left first coupling structure 6122, the left first contact surface 641, the plate body 631, the right second coupling structure 632, the right third contact surface 643, the right protruding body 6121 in sequence and flows back to the winding portion 611. It is to be noted that percentages of the two branches of the magnetic flux 65 may vary by adjusting the size of the first coupling structures 6122 and the second coupling structures 632. The first coupling structure 6122 and the second coupling structure 632 guide the magnetic flux 65 to reach edge areas C to increase the magnetic permeability utilization of the magnetically permeable units 61 and 63. Hence, the inductance of the transformer structure 6 is improved. Furthermore, the magnetic flux 65 orthogonally or substantially orthogonally passes the first contact surfaces 641 and the third contact surface 643, and this condition significantly reduces the flux leakage between the two magnetically permeable units 61 and 63.

Various modifications may be made to the coupling structures. For example, at one side of the transformer structure, a plurality of first coupling structures extend from the protruding body and a plurality of second coupling structures extend from the plate body. The first coupling structures and the second coupling structures are alternatively arranged along the widthwise direction of the plate body. The positions of the first coupling structures at different sides of the transformer structure are staggered along the widthwise direction of the plate body and so do the positions of the second coupling structures. In another embodiment, a portion of the first coupling structures may be omitted. In a further embodiment, a portion of the second coupling structures may be omitted.

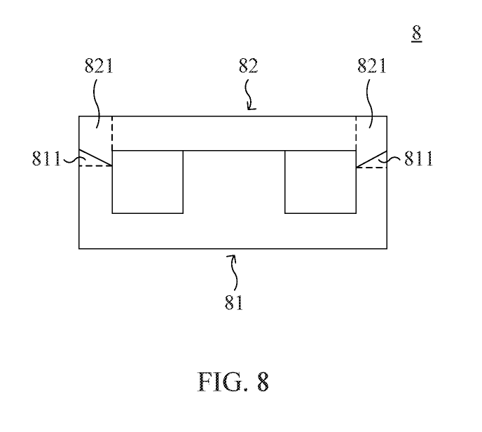

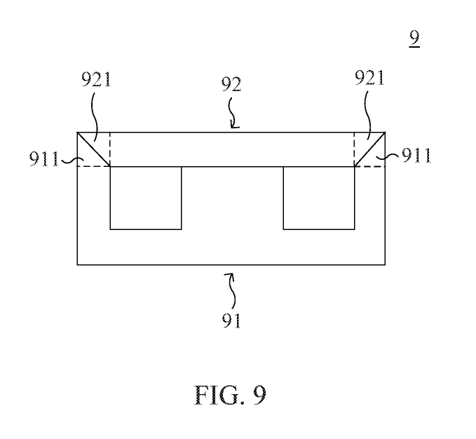

It is to be noted that the core types of the magnetically permeable units are not limited to the above embodiments. Please refer to FIG. 8 and FIG. 9, illustrating further embodiments of transformer structures 8/9 according to the present disclosure. The first magnetically permeable unit 81/91 may be an E-type core and the second magnetically permeable unit 82/92 may be an I-type core. In FIG. 8, the first coupling structure 811 has a shape of a triangular prism with a right triangle base, and the second coupling structure 821 has a shape of a tetragonal prism with a right-angled trapezoid base. In FIG. 9, both the first coupling structure 911 and the second coupling structure 921 have a shape of a triangular prism with a right triangle base. In another embodiment, the coupling structures of the E-type core and the I-type core may have a shape of a rectangular cuboid as described with reference to FIG. 6B.

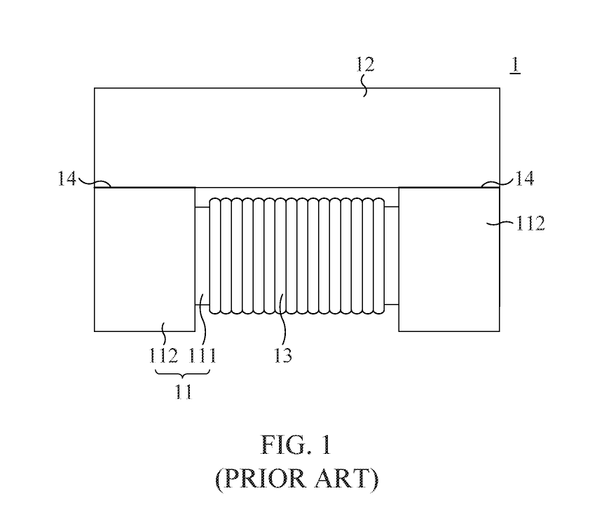

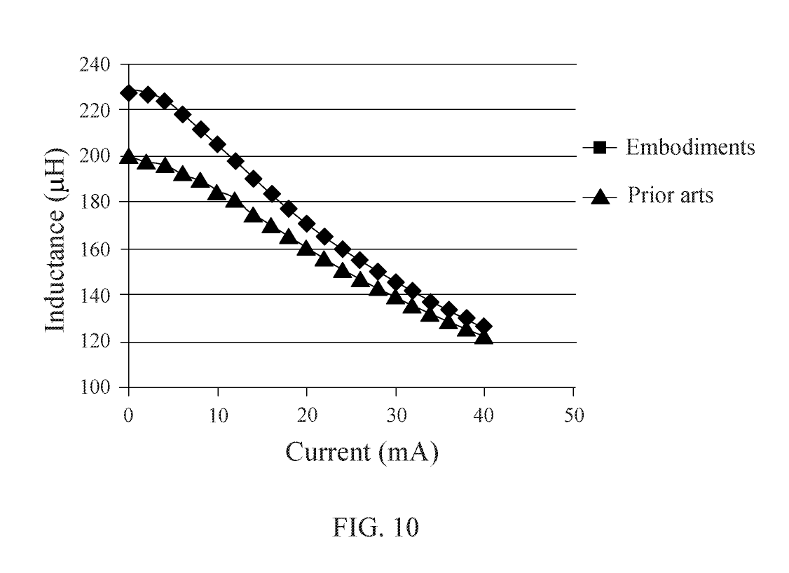

Please refer to FIG. 10, a plot showing relation between the inductance and the current of the present transformer structure and the conventional transformer structure. The upper curve corresponds to the embodiments of FIGS. 3A, 5A, 5B or 6A, and the lower curve corresponds to the prior arts as shown in FIG. 1. The measured inductance varies with the current input for the windings. Referring to FIG. 10, for the same current input, the present transformer structure has higher inductance than the conventional transformer structure. Therefore, it is proved that the transformer structure according to the present disclosure has improved inductance and magnetic permeability utilization of the magnetically permeable units.

Besides, the dimension D1 (length)*D2 (width)*D3 (height) of the transformer structure may be, but is not limited to, 4.5 mm*3.2 mm*2.2 mm, 4.5 mm*3.2 mm*2.9 mm, 4.5 mm*3.2 mm*3.4 mm, 3.2 mm*3.2 mm*2.9 mm, 4.65 mm*3.45 mm*1.8 mm, 5.28 mm*3.245 mm*3.4 mm or 6 mm*5 mm*3 mm.

In conclusion, the first coupling structure and the second coupling structure are provided to lead or guide the magnetic flux resulting from the windings wound around the winding portion. The contact surface between the first coupling structure and the second coupling structure is not parallel to the lengthwise direction of the second magnetically permeable unit. In other words, the first coupling structure and the second coupling structure extend to the edge area of the transformer structure so that the magnetic flux is guided to the edge area before entering the other magnetically permeable unit. Hence, the flux density at the edge area increases so that the magnetic permeability utilization of the magnetically permeable units and the inductance of the transformer structure are enhanced.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer structure comprising:
a first magnetically permeable unit having a winding portion and a protruding portion connected to an end of the winding portion, the protruding portion comprising a protruding body and a first coupling structure connected to the protruding body;
at least one winding wound around the winding portion of the first magnetically permeable unit to generate magnetic flux in the winding portion of the first magnetically permeable unit; and
a second magnetically permeable unit comprising a second coupling structure coupled to the first coupling structure,
the first coupling structure and the second coupling structure extending to an edge area of the transformer structure, the magnetic flux from the winding portion of the first magnetically permeable unit flowing to the protruding body, the first coupling structure and the second coupling structure in sequence.

2. The transformer structure according to claim 1, wherein the protruding body and the first coupling structure are made of the same material and integrally formed.

3. The transformer structure according to claim 1, wherein the second magnetically permeable unit further comprises a plate body connected to the second coupling structure, the magnetic flux from the winding portion of the first magnetically permeable unit flowing to the protruding body, the first coupling structure, the second coupling structure and the plate body in sequence.

4. The transformer structure according to claim 3, wherein the plate body and the second coupling structure are made of the same material and integrally formed.

5. The transformer structure according to claim 1, wherein a slant surface of the first coupling structure is connected to a slant surface of the second coupling structure to form a contact surface between the first coupling structure and the second coupling structure and couple the first coupling structure to the second coupling structure.

6. The transformer structure according to claim 5, wherein a binder is applied to the contact surface.

7. The transformer structure according to claim 1, wherein the edge area is a right-angled edge area defined by the coupled first and second coupling structures.

8. The transformer structure according to claim 1, wherein the first coupling structure has a shape of a triangular prism with a right triangle base or a shape of a tetragonal prism with a right-angled trapezoid base.

9. The transformer structure according to claim 1, wherein the second coupling structure has a shape of a triangular prism with a right triangle base or a shape of a tetragonal prism with a right-angled trapezoid base.

10. The transformer structure according to claim 1, wherein the first magnetically permeable unit is a drum core and the second magnetically permeable unit is a plate core.

11. The transformer structure according to claim 1, wherein the first magnetically permeable unit is an E-type core and the second magnetically permeable unit is an I-type core.

12. A transformer structure comprising:
a first magnetically permeable unit having a winding portion and a protruding portion connected to an end of the winding portion, the protruding portion comprising a protruding body and a first coupling structure connected to the protruding body;
at least one winding wound around the winding portion of the first magnetically permeable unit to generate magnetic flux in the winding portion of the first magnetically permeable unit; and
a second magnetically permeable unit comprising a plate body and a second coupling structure connected to the plate body,
the first coupling structure and the second coupling structure extending to an edge area of the transformer structure at least one side of the transformer structure,
a first portion of the magnetic flux flowing from the winding portion of the first magnetically permeable unit to the protruding body, the first coupling structure and the plate body in sequence,
a second portion of the magnetic flux flowing from the winding portion of the first magnetically permeable unit to the protruding body, the second coupling structure and the plate body in sequence.

13. The transformer structure according to claim 12, wherein the protruding body and the first coupling structure are made of the same material and integrally formed.

14. The transformer structure according to claim 12, wherein the plate body and the second coupling structure are made of the same material and integrally formed.

15. The transformer structure according to claim 12, wherein the first coupling structure and the second coupling structure have a shape of a rectangular cuboid, a height of the first coupling structure corresponding to a thickness of the second magnetically permeable unit, a length of the second coupling structure corresponding to a width of the protruding portion of the first magnetically permeable unit.

16. The transformer structure according to claim 12, wherein a lateral surface of the first coupling structure is connected to a lateral surface of the second coupling structure to form a contact surface between the first coupling structure and the second coupling structure and couple the first coupling structure to the second coupling structure.

17. The transformer structure according to claim 12, wherein the protruding body of the first magnetically permeable unit is connected to the second coupling structure, and the plate body of the second magnetically permeable unit is connected to the first coupling structure.

18. The transformer structure according to claim 12, wherein the first magnetically permeable unit is a drum core and the second magnetically permeable unit is a plate core.

19. The transformer structure according to claim 12, wherein the first magnetically permeable unit is an E-type core and the second magnetically permeable unit is an I-type core.

20. The transformer structure according to claim 12, wherein the transformer structure comprises a plurality of the first coupling structures and a plurality of the second coupling structures, positions of the first coupling structures at different sides of the transformer structure being staggered along a widthwise direction of the plate body, the second coupling structures at different sides of the transformer structure being staggered along the widthwise direction of the plate body.
